(19) United States
(12) Patent Application Publication
(10) Pub. No.: US 2014/0324966 A1
(43) Pub. Date: Oct. 30, 2014

(54) OBTAINING HYPERLOCAL CONTENT FROM SOCIAL MEDIA

(71) Applicant: Microsoft Corporation, (US)

(72) Inventors: Shelly Farnham, Seattle, WA (US); Yuheng Hu, Tempe, AZ (US); Andres Monroy-Hernandez, Seattle, WA (US)

(21) Appl. No.: 13/871,804

(22) Filed: Apr. 26, 2013

(51) Int. Cl. H04L 12/58

(52) U.S. Cl. CPC H04L 51/20; H04L 51/32
USPC 709/204

(57) ABSTRACT

Hyperlocal information may be marshaled from social network postings, and may be analyzed to create content about a hyperlocality. In one example, tweets on the Twitter service are examined to determine the hyperlocality with which the tweets are associated. The tweets are then analyzed to identify trending terms, and events are identified based on the trending terms. Additionally, patterns of posting and re-posting are analyzed to identify prominent members in the hyperlocality. A user interface, such as a web page, may be created for the hyperlocality, where the user interface may identify events, topics, people, places, and postings associated with the hyperlocality.

### BACKGROUND

One type of information that people may be interested in obtaining online is information relating to a particularly locality, such as information relating to the neighborhood that a person lives in. Various online services allow people to obtain locality-focused information. For example, there are business directories organized by geography, and many search engines allow a user to perform a location-based search (e.g., “restaurant near 98052” to find a restaurant in Redmond, Wash.).

These techniques are generally effective at finding information that exists in an organized form, comes from a fixed set of sources, and does not change rapidly. Some types of local information may exist in this form—e.g., a directory of businesses in the downtown area of a small city. Even information that is subject to rapid change (e.g., local news) sometimes can be mined from a small number of sources, such as the web sites of the city's newspapers and other media outlets. However, much local information comes in other forms that are not well-summarized or well-indexed by the techniques described above. The rise of social media allows relevant information to come from a variety of sources, often in forms that are not well organized. For example, the existence of a gas leak on a particular suburban block might be known to individual people in the neighborhood even if it is not being reported on an established media outlet.

### SUMMARY

Hyperlocal information may be mined from social media, such as Twitter, and may be presented to people on a variety of devices. Posts on social media (of which tweets on the Twitter service are a non-limiting example) may be examined to identify the localities with which they are associated. A locality may be a geographic region of arbitrarily small size, such as a neighborhood of a city, a particular apartment building, a particular gated community in a suburb, etc.

For each locality, the posts may be examined to identify people who are particularly prominent within the community, and also to identify trending terms. Prominent people may be identified based on their number of followers within the community, the number of times their posts are mentioned or re-posted by other community members, or by other techniques. Trending terms may be identified by time-concentrated perturbations in the general frequency of words coming from that locality—e.g., given some word distribution for tweets coming from a particular neighborhood for the last month, a spike in the frequency of a word over the last two hours may suggest that word is trending.

Events may be identified as being associated with specific groups of trending words, and posts may be clustered based on the trending words that they contain. A user interface (e.g., a web page, a smart phone app screen, etc.) may be created that highlights the detected events. The interface may also display topics that are of interest to the community, and may also contain a running feed of posts about the locality from people who have been identified as being associated with the community. Users may view this interface in order to learn, in real time, information about their own community gleaned from the postings of people associated with the community, thereby providing real-time crowd-sourced about the community.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process of collecting and analyzing social media data, and of using the social media data to create local content.

FIG. 2 is a block diagram of an example set of posts being assigned to localities.

FIG. 3 is a block diagram of example ways in which a person may be identified as being prominent.

FIG. 4 is a block diagram of an example comparison of word frequencies.

FIG. 5 is a block diagram of an example clustering of posts based on trending words.

FIG. 6 is a block diagram of an example user interface that allows users to interact with local content.

FIG. 7 is a block diagram of example components that may be used in connection with implementations of the subject matter described herein.

### DETAILED DESCRIPTION

People often use online services to obtain local information. For example, it is possible to perform a geographically-focused search, such as a search for “restaurant in Redmond, Wash.”. Similarly, people can obtain information about the weather, local news from traditional sources, etc. Traditional methods of obtaining local information tend to work well when the information comes in an organized form from a fixed set of sources, and/or when the information does not change rapidly. For example, a business directory may contain listings of restaurants, banks, etc., and these listings can be indexed and searched. News that comes from well-known traditional news outlets such as newspapers or television stations can be canvassed, and information gleaned from these outlets can be aggregated and presented for a user to read.

However, much local information does not come from traditional or well-organized sources, but rather from social media. Many people tend to post their thoughts or observations on social networking sites such as Facebook, Twitter, etc., and this information can be a rich source of information about localities—particularly very small localities (or “hyperlocalities”) such as specific neighborhoods of a city. A very local event such as a block party, a gas leak, road construction, etc., might not be reported in traditional, organized media, but the raw information about these events might be readily available on social media. The main challenge in using this information is to identify, marshal, and organize the raw information.

The subject matter described herein provides a way to collect and present information about localities. Local information is mined from social media, and is then analyzed to create a presentation of that information. In order to mine the information from social media, posts (e.g., “tweets” on the Twitter system) are received, and are analyzed to determine the geographic location associated with the posts or with the user who created the post. (Tweets may be received and analyzed in accordance with applicable privacy policies, in order to protect the posters' interest in privacy.) In some instances, the user may have self-reported his home location; in other cases, the location may be gleaned from the content or metadata associated with the post. Post are then assigned to neighborhoods, and a system that implements the subject matter herein then looks at the posts in that neighborhood to determine what events are occurring in the neighborhood.

Given some neighborhood and a corpus of posts associated with that neighborhood, the system determines the distribution of within the posts, or within some subset of the posts. For example, the system might determine the word frequencies for all posts for a given neighborhood over the last month. (The distribution over the last month may be continually recalculated—e.g., once per day, once per week, etc.—since distributions may change over time.) Posts may then be examined over a much smaller time window—e.g., the last two hours. If the content of posts over the small time window shows words whose frequencies are much greater than their frequencies over a longer period of time, then the spike in frequencies of those words constitutes a perturbation in the distribution of words, which may be interpreted as a trend. Posts may then be identified that contain several of the trend words, and the identified posts may be clustered based on which groups of trend words they contain. The trending posts may then be used to identify events that are currently occurring in the neighborhood, and these events may be presented on a user interface.

Additionally, posts may be examined to determine who is relatively prominent within a given neighborhood. A neighborhood may have a de facto community leader, and such a person may be identifiable based on factors such as how often that person posts about the neighborhood, or how often that person's posts are re-posted by others in the same neighborhood. Posts of identified community leaders may be featured on the user interface for a particular locality. Additionally, in determining what the trends are for a given neighborhood, posts from people who have been identified as being prominent may be weighed more heavily when determining which words are trending for the neighborhood. At a local level, it may be the case that who is saying something is just as significant as what the person is saying—e.g., at a local level, people may be willing to consider an event significant because one of the prominent people in the community is talking about that event.

Using the analysis of trending words and prominent people, content relating to the neighborhood may be constructed. For example, the analysis may be used to construct a web page for the locality, or locality-specific content that can be viewed through a mobile app on a smart phone or tablet. This content may contain events identified from the trending words, a list of topics that are frequently discussed for the locality, a running feed of posts from people who are talking about the locality, a list of prominent people in the locality, a list of popular places in the locality, or any other information.

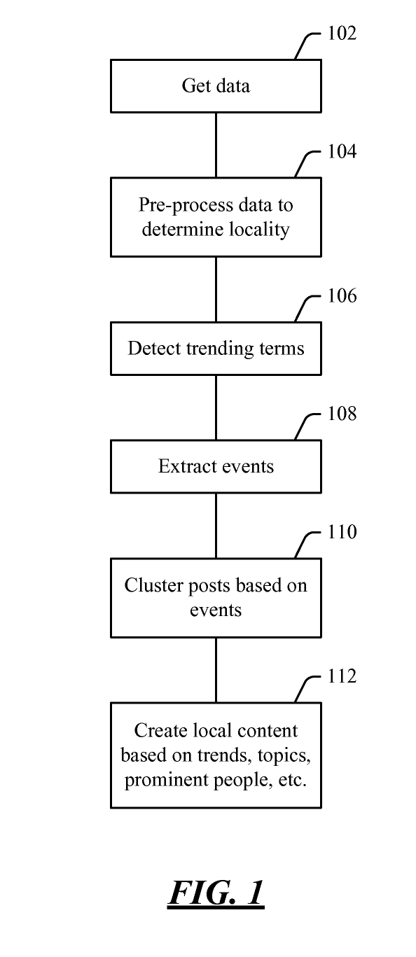

Turning now to the drawings, FIG. 1 shows an example process of collecting and analyzing social media data to create local content. At 102, social media data is received from a social media service. Examples of social media services include Twitter, Facebook, Google Plus, etc. The type of data that is received may be publicly-available posts made by members of the social media. In the case of the Twitter service, such posts are generally referred to as “tweets.” The description herein will refer to the Twitter service by name, and will use tweets on that service as the running example of social media data. However, it will be understood that other examples of social media data include posts on Facebook, Linkedln, Google Plus, or any other social media service, and that the subject matter described herein is not limited to the example of tweets on the Twitter service.

At 104, the data received from the social network service may be pre-processed. The pre-processing generally implements several goals. First, pre-processing attempts to determine which neighborhood a given post is associated with. People who post messages typically provide metadata (which they often agree to make publicly available) indicating the geographic areas with which they have an association. If the location data is publicly available, then a post may be identified as belonging to the neighborhood associated with its creator. In other cases, posts explicitly identify the place with which the posts are associated (e.g., a person might include the phase, “I am in Redmond” in a post, thereby indicating his probable location). In other cases, the location may be determined implicitly from information in the post—e.g., a post saying, “Gas leak across from El Gaucho” might be interpreted as identifying the Belltown section of Seattle since it refers to a famous restaurant located there (even though the text of the post does not explicitly mentioned Belltown or Seattle). Another way in which the location associated with a post might be determined is if the post is based on a check-in (which a high percentage of posts are)—e.g., if the user checks in at a restaurant and then posts his or her check-in, the location of the post can be presumed to match the location of the check-in.

Once posts have been assigned to a given locality, the following actions may be performed for those posts in that locality. At 106, trending terms in the posts may be detected. There are various ways to detect trending terms, but one such way is as follows. Trending terms may be identified by perturbations in the time-localized frequency of those terms, relative to some corpus. In the case of social network posts, the corpus may be delineated as including all of the posts for a given neighborhood in the last month (or two months, or six months, or some relatively long time period). For whatever collection of posts constitutes the corpus, the frequency of words in those posts may be calculated. Since the content of posts may migrate over time, the word frequency may be continually recalculated so that the frequency reflects a recent time window. Once the frequency of words has been calculated for the corpus of posts, a recent time window of shorter duration may be compared with the corpus. For example, the words occurring in the last two hours worth of posts may be compared with last month of posts, in order to determine which words have unusually high frequencies over the last two hours. Such words may be identified as trending words, and identifying sharp increases in frequency over a very short recent time period is an effective way to detect a trend in real time. As discussed below, some people may be identified has being particularly prominent to a locality, and the words contained in those people's most may be given correspondingly more weight when deciding which words are currently trending.

At 108, events may be extracted from the trending words. Topic modeling may be used to determine what events correspond to high frequency words. For example, the appropriate model may indicate that the words “gas,” “leak,” and “danger” all relate to a gas leak, so a high frequency of these words may suggest that a gas leak is a presently-occurring event. Events may be selected based on which words have been identified as trending.

At 110, posts may be clustered based on which events they appear to relate to. The clustering may be based on which high-frequency words appear in the tweets. For example, if there is a cluster around the “gas leak” event, and that cluster is defined by the presence of the words “gas,” “leak,” and “danger” in a post, then post that contain high frequencies of these words may be clustered with the gas leak event. A given post may be clustered with more than one event, if the post contains words that correspond closely to more than one cluster.

At 112, local content may be created. The local content may be based on events detected through the trending words. The content may also contain other information, such as topics that are frequently discussed in the community, lists of prominent people, active places, recent posts relating to the locality, etc. This local content may made available for viewing (or may otherwise be communicated to users)—e.g., as a page viewable with a web browser, or content viewable through an application (“app”).

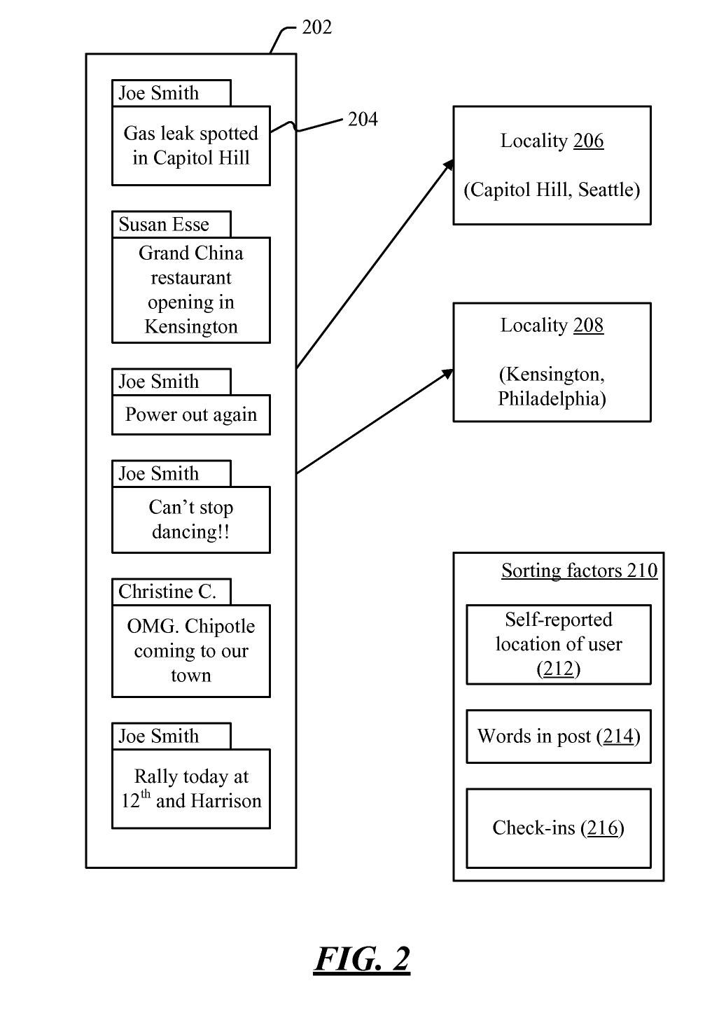

FIG. 2 shows an example of posts being examined to determine the locality to which they belong. The posts shown in FIG. 2 are tweets on the Twitter system, although, as noted above, the post may be any type of posts. The sorting of posts into localities is an example action that may happen in the pre-processing act performed at 104 (of FIG. 1). Set 202 is a set of posts. For example, post 204 is one of the posts in set 202, and post 204 contains a name of the person making the post “Joe Smith”, and content within the post. The various posts may be associated with different localities. Two example localities 206 and 208 are shown in FIG. 2: one for the Capitol Hill neighborhood of Seattle; the other for the Kensington neighborhood of Philadelphia. Posts may be identified as belonging to one of these neighborhoods (or to any other neighborhood not shown in the figure).

Some example factors 210 that may be used to assign a post to a given neighborhood are shown in FIG. 2. One example factor is the self-reported location of the user who created the post (block 212). For example, when the user signs up for a Twitter account, he may provide his home location, and the user's posts may be associated with this self-reported location. (In order to protect the user's interest in privacy, the user's self-reported location may be used pursuant to appropriate permission obtained from the user.) In another example, the location may be determined based on the words in a post (block 214). For example, the post may contain words explicitly identifying the location to which the post relates (e.g., “Belltown, Seattle, Wash.”), or implicitly identifying that location (e.g., “across the street from El Gaucho”). As another example, the post may be a declaration that the user has checked into a particular location (block 216), in which case the post may be associated with the location of the check in. (A relatively high percentage of posts exist to declare that the user has checked in using Foursquare or some other location-based system.)

The following is an example way in which posts may be identified as belonging to a particular neighborhood. Out of all available posts, a system may identify those that are posted by people who claim to live in a specific metropolitan area (e.g., Seattle, Chicago, etc.). The system may make this determination by looking at public information—e.g., on Twitter, location information entered by a user is typically part of the user's public profile that the user makes available for all to see. Posts may be associated with the metropolitan area that has been identified by the person making the post. Once posts have been associated with metropolitan areas, the system may use the content of the post itself to identify the neighborhood. For example, if a post has been associated with a metropolitan area and also contains the name of a specific neighborhood (or some similar indicia of a neighborhood) in that metropolitan area, then the post may be associated with the neighborhood.

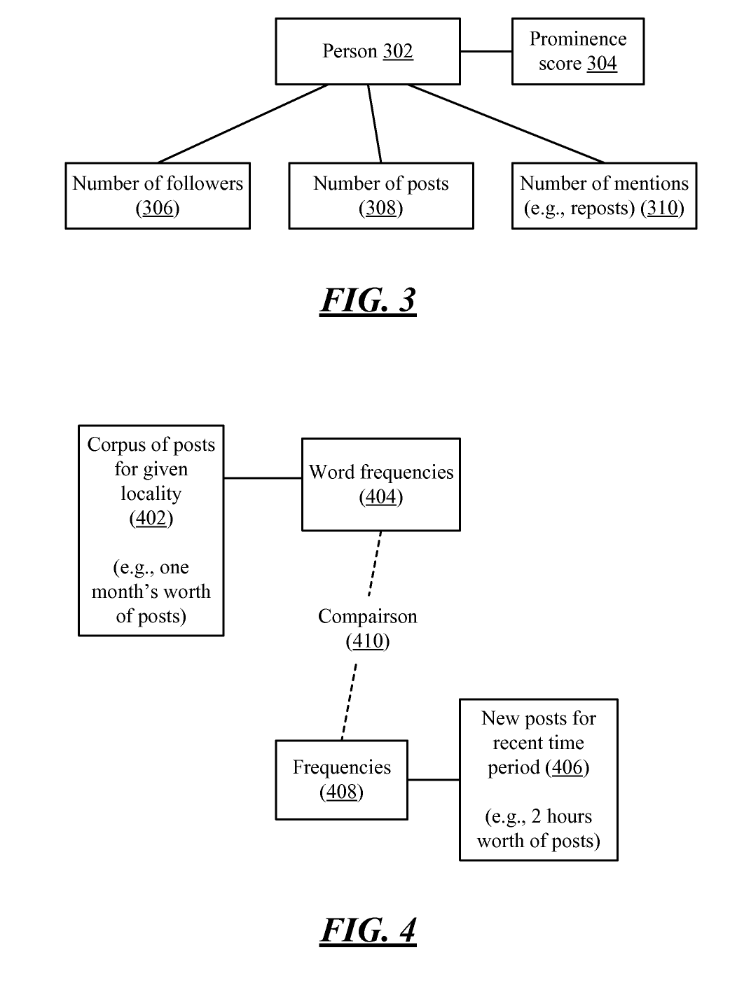

As noted above, certain people may be identified as being prominent within a particular locality, and this identification of prominence may be used in various ways to create locality-focused content. FIG. 3 shows example ways in which a person may be identified as being prominent. Person 302 is a person who posts on a post on a social network. Person 302 may be assigned a prominence score 304 based on factors, such as those shown in FIG. 3. One example factor is the number of followers 306 that person 302 has. Another example factor is the number of posts 308 that person 302 has made. Another example factor is the number of mentions (e.g., retweets) (item 310) that have been made of person 302's posts. Person 302's prominence score 304 is focused on a particular locality, in order to determine not just how prominent person 302 is in general, but rather how prominent he or she is in a particular locality. Thus, when determining prominence score 304, it is the number of followers in a particular community, the number of posts relating to the community, and he number of times that person 302's post have been mentioned by members of that community, that count. A famous movie star might have a larger number of followers overall than person 302, but relatively few of those followers might be from a specific neighborhood; followers outside of a specific neighborhood might not contribute much to a person's prominence score for that neighborhood.

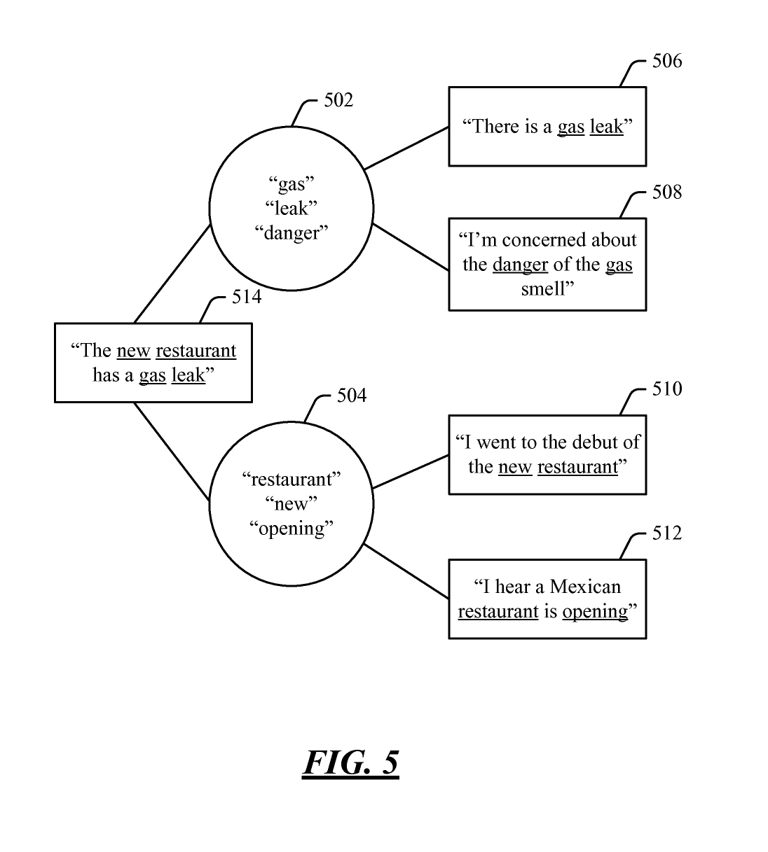

As noted above in connection with FIG. 1, trending words in posts may be identified by comparing the frequency of words in posts over a short time horizon with frequencies over a longer time horizon. FIG. 4 shows an example of how such a comparison is made.

Corpus 402 is a set of posts for a given locality—e.g., it may be posts relating to the community of Capitol Hill in Seattle. Corpus 402 may be defined as all of the post for a locality over a particular time horizon that is relatively long—e.g., all of the posts relating to Capitol Hill for the last month. In other examples, the last two months or three months worth of posts may be used. Word frequencies 404 represent the distribution of word occurrences over the corpus. For example, in a given corpus, 1% of the words might be the word “restaurant,” 1.5% might be the word “school,” etc.

New posts 406 represent a set of posts made over a relatively short, recent time period—e.g., the last two hours of posts. Frequencies 408 may be calculated for the new posts, and a comparison 410 may be made between frequencies 408 and frequencies 404. Words whose frequencies are significantly higher among the new posts among the older posts may be identified as being trending words.

More precisely, to identify trending features from a substantial volume of posts, one first needs to figure out what is trending. Inspired by a theoretical busty model, one may define trending as a time interval over which the rate of change of momentum (i.e., product of mass and velocity) is positive. One further may define that mass as s the current importance of the feature and the velocity as the rate of change of the feature's frequency in posts, during a time period. Since it is hard to measure the momentum from these values directly, one may use the trend analysis tools EMA (Exponential Moving Average), MACD (Moving Average Convergence Divergence), and MACD histogram from the quantitative finance literature. They yield established measures of momentum and hence satisfy the problem well. These tools may be used to identify trending features from Twitter posts.

Given a feature F and its time series S(F)={f₁, f₂, . . . fₘ}, fᵢ denotes the frequency that F is mentioned by the posts posted within the i-th period. For example, the word “Morning” can have a time series S={248,305,154,52,24,9} from 8 a.m. to 2 p.m. of the day, in which it was mentioned 248 times by the posts from 8 a.m. to 9 a.m. and so on. Moving averages are commonly used with time series data to smooth out short-term fluctuations and highlight longer-term trend. Here, one may compute the n-hour EMA for S(F) as: EMAᵢ=α×fᵢ+(1−α)×EMAᵢ₊₁ where α=2/(n+1) is a smoothing factor, n is a time lag, and 1≦i≦m is the index of time period. Effectively, the EMA smoothens out noises of F by averaging its time series over a specific number of periods. Next, to spot changes in the momentum of F, one may compute the MACD statistics which is defined as the difference between the n₁- and n₂-hour EMA for S(F), where n₁ and n₂ are time lags. Finally, to identify whether and when F is trending, one may quantify the rate of change of its momentum. Therefore, one may calculate the MACD histogram, defined as the difference between F's MACD and its signal line (the n-day EMA of MACD). As this measures the rate of change, the result at a given time period can be either positive (indicating F is trending up) or vice versa.

In some cases, the trending features may occur repeatedly. For example, “Morning” can be trending from 8 a.m. to 11 a.m. every day. Such trending feature may be less interesting compared to the ones which are “one-time” and non-recurring. To resolve this problem, one may assign a “novelty” score to the identified trending feature according to its deviation from their expected trend. More specifically, for a trending feature F, one may denote R(h,d,w,F) as its MACD histogram result during hour h, day d, and week w. With this notation, one can compare F's trend in a specific day/hour in a given week to the same day/hour in other weeks (e.g., 9 a.m. on Monday, Aug. 6, 2012, vs. the trend on other Mondays at 9 a.m.). Let Mean(h,d,F) and SD(h,d,F) denote the average trend and the standard deviation of F on hour h and day d over week w₁ to wₙ, respectively. Then, the novelty score of feature F on hour h, day d, and week w is defined as: Score(h,d,F)=[R(h,d,w,F)−Mean(h,d,F)]/SD(h,d,F). Based on this score, one may rank each feature to find the novel trending features.

In practice, to detect the daily active events, one may first build a dictionary of features from all the Twitter posts of one day. Then, one may create a time series for each feature by counting their frequencies in Twitter posts in every two hours. As a result, there is a 12-hour long time series for each feature. Then, one may applied the EMA, MACD and MACD histogram over the time series data to identify whether and when a feature is trending. Finally, for every 2 hours, one may pick the trending feature which (1) is least mentioned 20 times in the Twitter posts from that time period, and (2) has a novelty score among the top 25 scores for all trending feature from that time period. Since these steps are computable in an online fashion, this approach can be highly efficient.

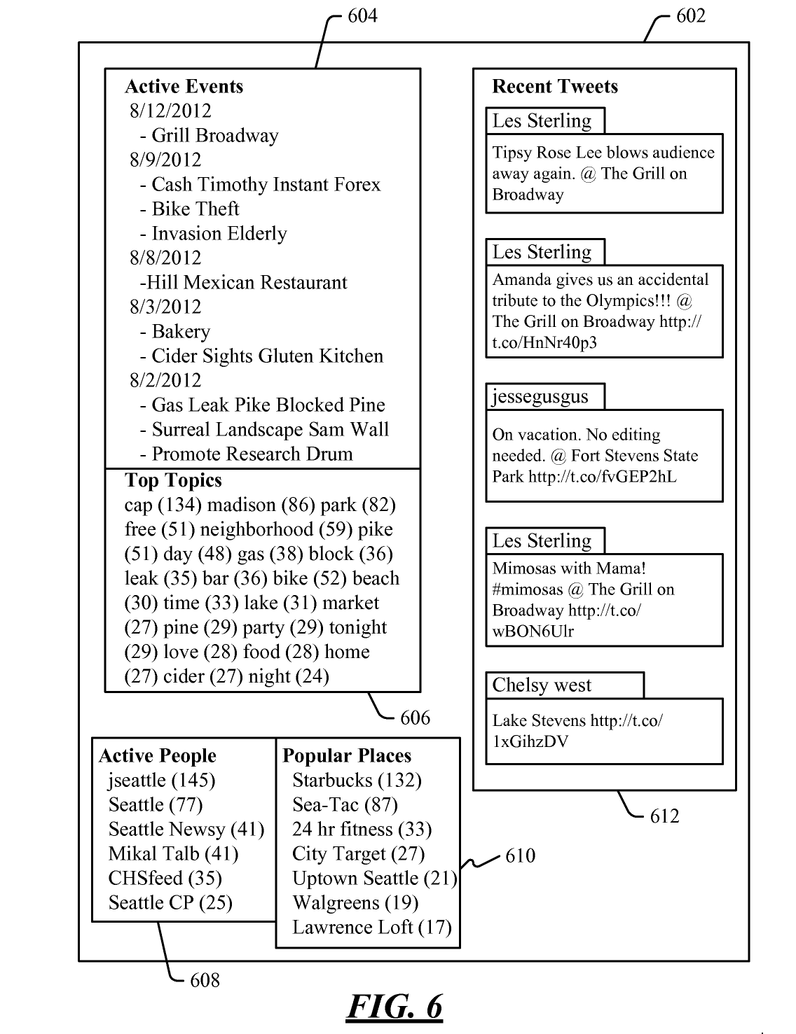

As noted above, posts may be clustered together based on the trending words that they contain. FIG. 5 shows an example of this clustering.

Clusters 502 and 504 are separate clusters that are defined by specific words. For example, cluster 502 may be a cluster that relates to gas leaks. That cluster may be defined by the words “gas”, “leak”, and “danger.” Cluster 504 may be a cluster that relates to the opening of a new restaurant, and it is defined by the words “new”, “opening”, and “restaurant”. Posts 506, 508, 510, 512, and 514 may be assigned to clusters based on the fact that the posts contain a certain number of words that are associated with the cluster. For example, posts 506 and 508 each contain two words that are associated with cluster 502, and therefore are assigned to cluster 502. Posts 510 and 512 each contain two words that are associated with cluster 504, and therefore are assigned to cluster 504. A post may be assigned to more than one cluster. For example, post 514 contains two words associated with cluster 502, and also contains two words associated with cluster 504. Therefore, post 514 is assigned both to cluster 502 and to cluster 504.

To group the trending features into topically-related event-clusters, one may use the shared nearest neighborhood (SNN) clustering algorithm. This algorithm may be chosen since it is scalable and does not call for a priori knowledge of the number of clusters (as posts are constantly evolving and new events get added to the stream over time).

The SNN algorithm may be executed as follows: each trending feature is a node of the graph and each node is linked to another by an edge if it belongs to the k neighbor list of the second object. Here, one may define feature F1 is the neighbor of feature F2 only if F1 and F2 are topically-related (e.g., “Gas” can be a neighbor to “leak” but may not be a neighbor to “party”). To learn a feature's topic, one may use topic modeling, a popular machine learning tool for getting topic distributions from text. In order to measure the topical relationship between two features, one may use the Jensen-Shannon divergence on their topic distributions. As a result, if the distance is above a threshold, the two features are neighbors.

The assignment of posts to clusters may be used as part of the presentation of locality-based information. For example, once a gas leak has been detected as an event in a locality (based on the trending occurrence of words associated with a gas leak), posts from that locality relating to the gas leak may be assigned to clusters, and those posts may be shown on a web page for that locality.

As noted above, one goal of marshaling and organizing local information from social network posts is to create a web page (or other user interface) that allows users to view and/or interact with information for a locality. FIG. 6 shows an example of such an interface.

Interface 602 is a user interface that allows a user to view and/or interact with local content. In the example of FIG. 6, interface 602 is shown in the form of a web page. However, interface 602 may take any appropriate form. Interface 602 represents local content for the Capitol Hill neighborhood of Seattle. Interface 602, in this example includes active events 604, topics 606, active people 608, popular places 610, and a feed 612 of recent posts about the neighborhood. Events 604 may be detected from trending topics.

Events 604 may be ordered by time (e.g., recent first), and each event may be indicated by the trending words that have been detected and that relate to the event. Clicking on a particular line of words may cause interface 602 to display the posts associated with that event (i.e., the post that contain the trending words, or some portion of the trending words). Topics 606 may be topics that are often discussed in connection with the neighborhood to which interface 602 relates. A difference between events 604 and topics 606 is that events may be relatively short-lived occurrences that are discussed over a short time horizon, while topics may be subjects that are discussed in an ongoing way over a long time horizon.

Active people 608 may be people who have posted about the neighborhood recently. The list may be ordered based on the number of posts, or based on the prominence of the people (which may be determined using techniques described above). Popular places 610 may be places that are in the neighborhood, or that have been discussed in posts about the neighborhood. Feed 612 is a running list of posts about the neighborhood.

FIG. 6 shows an example interface, although other implementations are possible. In one example, an interactive map showing the neighborhoods may be displayed, and words (e.g., trending words, topics, names of prominent members of the neighborhood, etc.) may be shown in the neighborhoods with which they are associated.

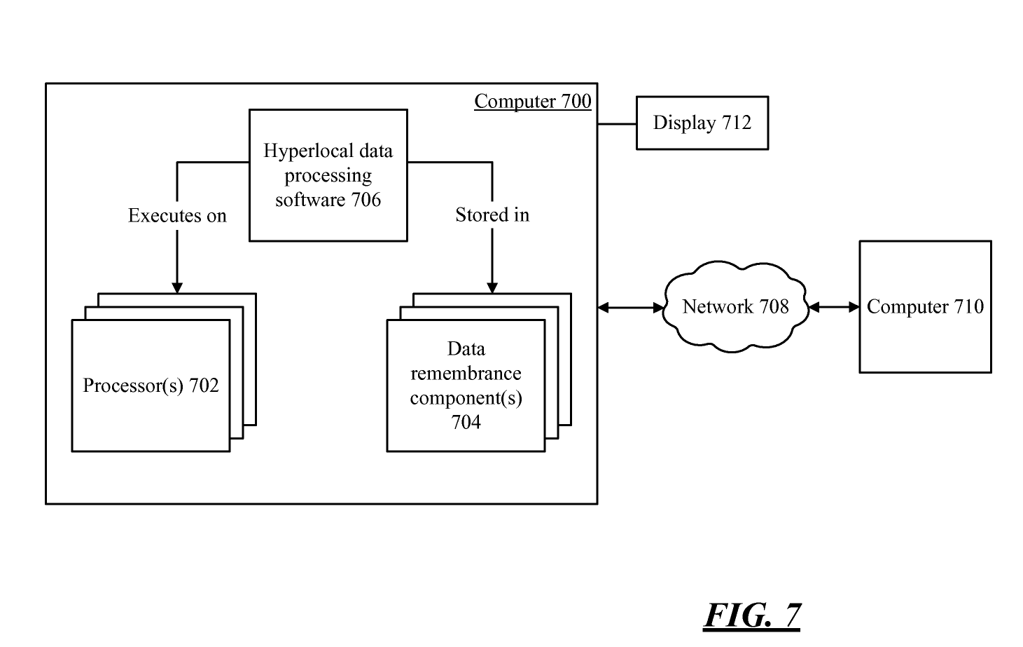

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is hyperlocal data processing software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium.

Computer-readable media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable storage medium that stores executable instructions to present local information, the executable instructions, when executed by a computer, causing the computer to perform acts comprising:
receiving posts from a social network;
identifying a plurality of said posts as being associated with a locality;
identifying trending words in said plurality of posts;
identifying clusters of said trending words that correspond to events;
assigning said plurality of posts to clusters based on which of said trending words appear in said posts;
creating local content that comprises events determined from said trending words; and
communicating said local content to a user.

2. The computer-readable storage medium of claim 1, said identifying of said trending words comprising:
comparing first frequencies of words in posts over a first duration with second frequencies of said words in posts over a second duration; and
identifying terms as trending that have greater frequencies in said first duration than in said second duration, said second duration being longer than said first duration.

3. The computer-readable storage medium of claim 1, said acts further comprising:
identifying said events as occurring based on said trending words including words that are associated with said events.

4. The computer-readable storage medium of claim 1, said acts further comprising:
identifying a prominent person in said locality based on a number of followers in said locality that said person has.

5. The computer-readable storage medium of claim 1, said acts further comprising:
identifying a prominent person in said locality based on a number of times that posts of said person are re-posted by other members of the locality.

6. The computer-readable storage medium of claim 1, association of said locality with said plurality of posts being based on self-reported locations of a users who created said posts, or based on words in said posts.

7. The computer-readable storage medium of claim 1, association of said locality with said plurality of posts being based on locations of check-ins declared by said posts.

8. A method of presenting local information, the method comprising:
using a processor to perform acts comprising:
receiving posts from a social network;
identifying a plurality of said posts as being associated with a locality;
identifying trending words in said plurality of posts by comparing first frequencies of words in posts over a first duration with second frequencies of said words in posts over a second duration and identifying terms as trending that have greater frequencies in said first duration than in said second duration, said second duration being longer than said first duration;
identifying clusters of said trending words that correspond to events;
assigning said plurality of posts to clusters based on which of said trending words appear in said posts;
creating local content that comprises events determined from said trending words; and
communicating said local content to a user.

9. The method of claim 8, said acts further comprising:
identifying said events as occurring based on said trending words including words that are associated with said events.

10. The method of claim 8, said acts further comprising:
identifying a prominent person in said locality based on a number of followers in said locality that said person has.

11. The method of claim 8, said acts further comprising:
identifying a prominent person in said locality based on a number of times that posts of said person are re-posted by other members of the locality.

12. The method of claim 8, association of said locality with said plurality of posts being based on self-reported locations of a users who created said posts, or based on words in said posts.

13. The method of claim 8, association of said locality with said plurality of posts being based on locations of check-ins declared by said posts.

14. A system for presenting local information, the system comprising:
a memory;
a processor; and
a component that is stored in said memory, that executes on said processor, that receives posts from a social network, that identifies a plurality of said posts as being associated with a locality, that identifies trending words in said plurality of posts, that identifies clusters of said trending words that correspond to events, that assigns said plurality of posts to clusters based on which of said trending words appear in said posts, that creates local content that comprises events determined from said trending words, and that communicates said local content to a user.

15. The system of claim 14, said component identifying said trending words by comparing first frequencies of words in posts over a first duration with second frequencies of said words in posts over a second duration, and by identifying terms as trending that have greater frequencies in said first duration than in said second duration, said second duration being longer than said first duration.

16. The system of claim 14, said component identifying said events as occurring based on said trending words including words that are associated with said events.

17. The system of claim 14, said component identifying a prominent person in said locality based on a number of followers in said locality that said person has.

18. The system of claim 14, said component identifying a prominent person in said locality based on a number of times that posts of said person are re-posted by other members of the locality.

19. The system of claim 14, association of said locality with said plurality of posts being based on self-reported locations of a users who created said posts, or based on words in said posts.

20. The system of claim 14, association of said locality with said plurality of posts being based on locations of check-ins declared by said posts.
